(19) United States
(12) Patent Application Publication
(10) Pub. No.: US 2011/0317006 A1
(43) Pub. Date: Dec. 29, 2011

(54) INFORMATION PROCESSING APPARATUS AND OPERATION METHOD THEREOF

(75) Inventors: Hideo Kuboyama, Yokohama-shi (JP); Toshiaki Fukada, Yokohama-shi (JP)

(73) Assignee: CANON KABUSHIKI KAISHA, Tokyo (JP)

(21) Appl. No.: 13/170,372

(22) Filed: Jun. 28, 2011

(30) Foreign Application Priority Data
Jun. 29, 2010 (JP) 2010-148205

(51) Int. Cl. H04N 7/18

(52) U.S. Cl. 348/140; 348/E07.085

(57) ABSTRACT

According to known techniques, sometimes, it is not possible to estimate a position of a sound source (lips of mouth) depending on, for example, differences of colors of hair. To solve the problem, an information processing apparatus according to the present invention acquires a range image indicating a distance between an object and a reference position within a three-dimensional area, specifies a first position corresponding to a convex portion of the object within the area based on the range image, specifies a second position located in an inward direction of the object relative to the first position, and determines a position of a sound source based on the second position.

### BACKGROUND OF THE INVENTION

1. Field of the Invention

The present invention relates to techniques for estimating a position of a sound source.

2. Description of the Related Art

Conventionally, techniques for estimating a position of a sound source (lips of mouth) from images captured by a plurality of cameras installed on a ceiling are performed by specifying a spherical area where many hair color regions exist and estimating the area as the position of the sound source have been known, for example, in Japanese Patent Application Laid-Open No. 8-286680.

However, according to the conventional techniques, it is not always possible to accurately estimate the position of the sound source (lips) depending on differences of colors of hair, or the like.

### SUMMARY OF THE INVENTION

The present invention is directed to an information processing apparatus capable of accurately estimating a position of lips corresponding to a position of a sound source without depending on factors including a color of hair, or the like.

According to an aspect of the present invention, an information processing apparatus is provided. The information processing apparatus includes an acquisition unit configured to acquire a range image showing a distance between an object and a reference position within a three-dimensional area, a first specification unit configured to specify a first position corresponding to a convex portion of the object within the area based on the range image, a second specification unit configured to specify a second position located in an inward direction of the object to the first position, and a determination unit configured to determine a position of a sound source based on the second position.

According to the present invention, a position of lips corresponding to a position of a sound source can be accurately estimated without depending on factors including a color of hair, or the like.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are block diagrams illustrating configurations of an information processing apparatus 100.

FIGS. 2A and 2B illustrate examples of a range image sensor 110 and other units.

FIG. 3 is a flowchart illustrating a processing flow for emphasizing voice.

FIGS. 4A, 4B, and 4C schematically illustrate a range image and a three-dimensional space viewed in the vertical direction and the horizontal direction.

FIGS. 5A to 5E illustrate acquisition state of candidates of lip space coordinates from a head in a range image.

FIG. 6 is a flowchart illustrating a processing flow for setting a table position.

FIG. 7 is a flowchart illustrating detailed processing performed in step S305.

FIGS. 8A and 8B schematically illustrate exemplary extraction of heads.

FIG. 9 is a flowchart illustrating a processing flow for emphasizing voice.

FIGS. 10A and 10B are flowcharts illustrating a processing flow for suppressing voice.

FIG. 11 is a flowchart illustrating a processing flow for suppressing voice.

FIG. 12 is a flowchart illustrating a processing flow for recording emphasized voice while tracking a head.

### DESCRIPTION OF THE EMBODIMENTS

Various exemplary embodiments, features, and aspects of the invention will be described in detail below with reference to the drawings.

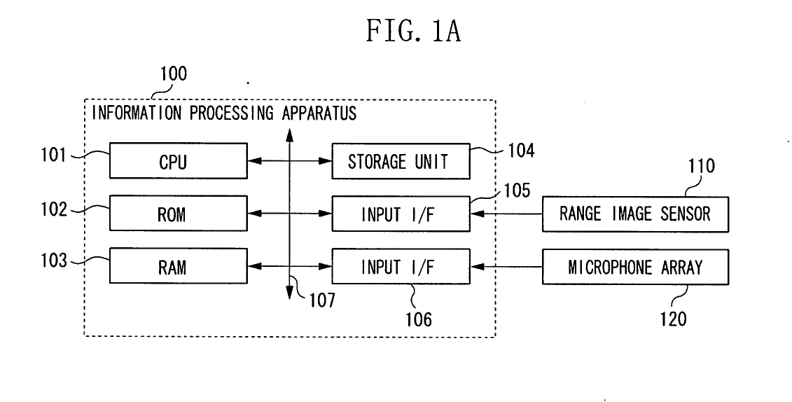

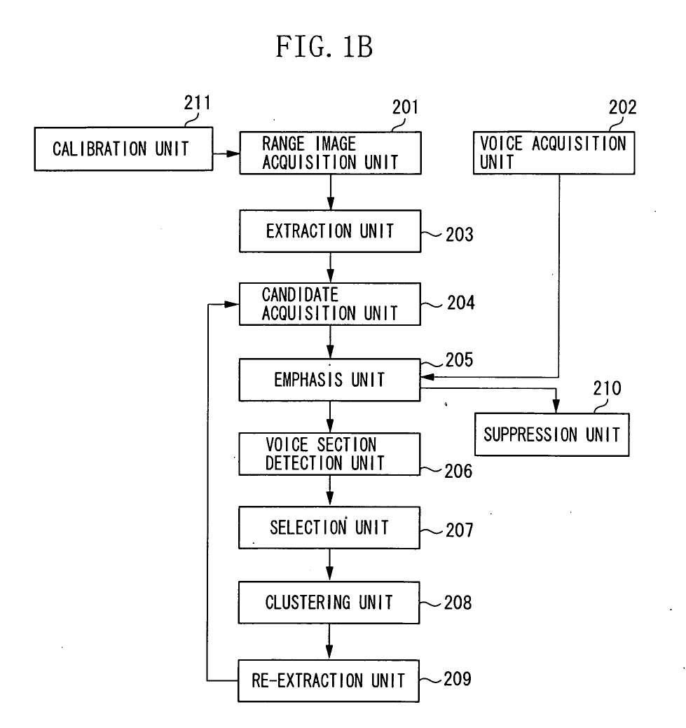

FIG. 1A is a block diagram illustrating a hardware configuration of an information processing apparatus 100 according to a first exemplary embodiment of the present invention.

In FIG. 1A, the information processing apparatus 100 includes a central processing unit (CPU) 101, a read-only memory (ROM) 102, a random access memory (RAM) 103, a storage unit 104, a first input interface (I/F) 105, and a second input I/F 106. Each component of the information processing apparatus 100 is interconnected with each other via a system bus 107. A range image sensor 110 is connected to the information processing apparatus 100, via the input I/F 105, and a microphone array 120 is connected to the information processing apparatus 100 via the input I/F 106.

Hereinafter, each component of the information processing apparatus 100, the range image sensor 110, and the microphone array 120 are described.

The CPU 101 loads a program or the like stored in the ROM 102 or the like in the RAM 103, and reads out the program, and thereby various operations of the information processing apparatus 100 are implemented. The ROM 102 stores the program for performing the various operations of the information processing apparatus 100, data, and the like necessary for the execution of the program. The RAM 103 provides a work area for loading the program stored in the ROM 102, or the like.

The storage unit 104 is a hard disk drive (HDD) or the like for storing various types of data. The input I/F 105 acquires data indicating a range image generated by the range image sensor 110, which is described in detail below. The range image is an image having pixel values of a distance between an object and a reference plane that exist within a predetermined three-dimensional area.

The input I/F 106 acquires data indicating voice acquired by the microphone array 120, which is described below. The range image sensor 110 generates, by reflection of, for example, infrared light, a range image that shows a distance between an object and a reference plane (for example, a plane that is perpendicular to a measurement direction of the range image sensor, and the range image sensor 110 exists) that exist in a predetermined three-dimensional area. The microphone array 120 includes a plurality of microphones, and acquires sounds of a plurality of channels.

In the present exemplary embodiment, by using the range image sensor 110, the range image is generated. However, instead of the range image sensor 110, using a plurality of cameras, a range image can be generated. In such a case, the range image is generated according to coordinates calculated from a position of an object that exists in the images captured by the plurality of cameras.

FIG. 1B is a block diagram illustrating a functional configuration of the information processing apparatus 100 of FIG. 1A according to the present exemplary embodiment.

The image processing apparatus 100 includes a range image acquisition unit 201, a voice acquisition unit 202, an extraction unit 203, and a candidate acquisition unit 204. Further, the information processing apparatus 100 includes an emphasis unit 205, a voice section detection unit 206, a selection unit 207, a clustering unit 208, a re-extraction unit 209, a suppression unit 210, and a calibration unit 211.

The range image acquisition unit 201 corresponds to the input I/F 105 of FIG. 1A, and the voice acquisition unit 202 corresponds to the input I/F 106 of FIG. 1A. Each of the units 203 to 211 is implemented by the CPU 101 of FIG. 1A by loading a predetermined program or the like stored in the ROM 102 of FIG. 1A or the like in the RAM 103 of FIG. 1A, and reading the program. Hereinafter, each unit is described.

The range image acquisition unit 201 acquires a range image acquired by the range image sensor 110 of FIG. 1A. The voice acquisition unit 202 acquires a plurality of voices acquired via each of the plurality of microphones that form the microphone array 120 of FIG. 1A. The extraction unit 203 extracts pixels corresponding to a head (the top of the head) of a person from the range image acquired by the range image acquisition unit 201.

The candidate acquisition unit 204 acquires one or more candidates (lip space coordinate candidates) of a space coordinate of lips based on the pixels indicating the head (the top of the head) extracted by the extraction unit 203. The emphasis unit 205 emphasizes voices in directions from the space coordinates to the installation positions of the microphones with respect to each of the lip space coordinate candidates.

The voice section detection unit 206 detects sections of human voices out of the sounds acquired by the voice acquisition unit 202. The selection unit 207 selects one voice based on the volume from the one or more voices emphasized by the emphasis unit 205 for each of the lip space coordinate candidates. The clustering unit 208 performs clustering on the emphasized voice selected by the selection unit 207 and calculates the number of speakers included in the emphasized voice.

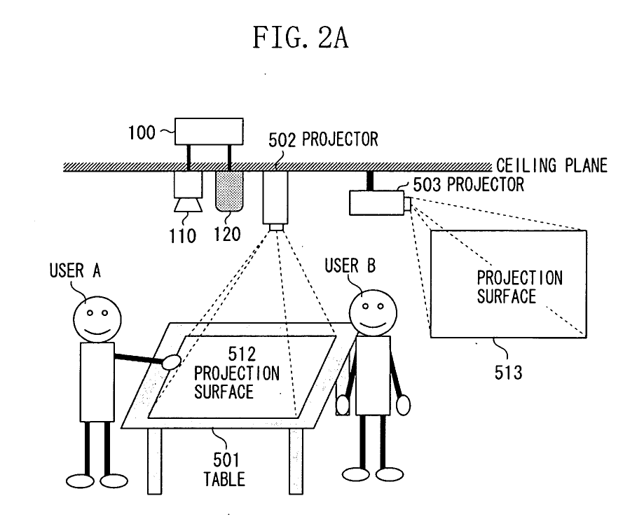

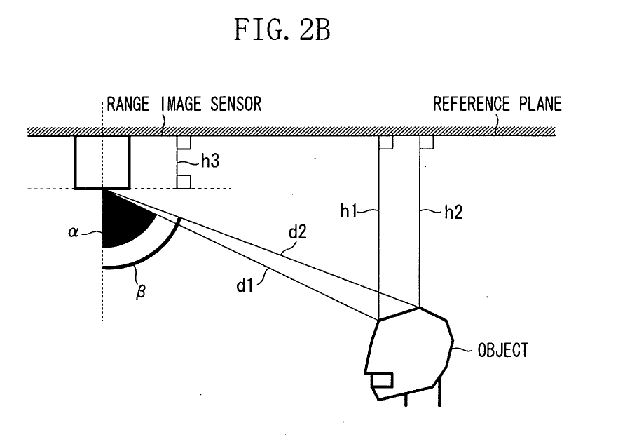

The re-extraction unit 209 re-extracts heads corresponding to the number of speakers detected by the clustering unit 208 from the heads extracted by the extraction unit 203 and peripheral areas of the heads. The suppression unit 210, relative to the emphasized voice of a head (a target head in the extracted heads), suppresses (restricts) components of the emphasized voices of the other heads (heads other than the target head in the extracted heads). The calibration unit 211 determines coordinates of an object (in the present exemplary embodiment, a table 501, which is described below in FIG. 2A) that is set in advance.

FIG. 2A illustrates an example of the installation state of the range image sensor 110 and the microphone array 120.

In FIG. 2A, it is assumed that the range image sensor 110 and the microphone array 120 are installed on a ceiling of a room (conference room, for example). The range image sensor 110 generates a range image that shows a distance between an object (for example, a user A, a user B, a table 501, a floor of the conference room, or the like) and a reference plane (for example, the ceiling plane). In the conference room, the table 501 and projectors 502 and 503 are installed, in addition to the range image sensor 110 and the microphone array 120.

The table 501 also functions as a projection surface 512 of the projector 502, and can display an image. The projector 503 can display an image on a wall surface (projection plane 513) of the conference room.

The information processing apparatus 100 can be installed at any position locally or remotely as long as the above-described predetermined data can be acquired from the range image sensor 110 and the microphone array 120.

FIG. 2B schematically illustrates a distance to be acquired using the range image sensor. As described above, the range image is an image having pixel values of a distance between an object and a reference plane that exist within a predetermined three-dimensional area.

In the present exemplary embodiment, the pixel value of each pixel is determined using distances h1 and h2 calculated from distances d1, d2, and h3, and angles α and β. In a case where the angles α and α have angles close enough to 0°, the distances d1 and d2 themselves can be considered as the distances h1 and h2.

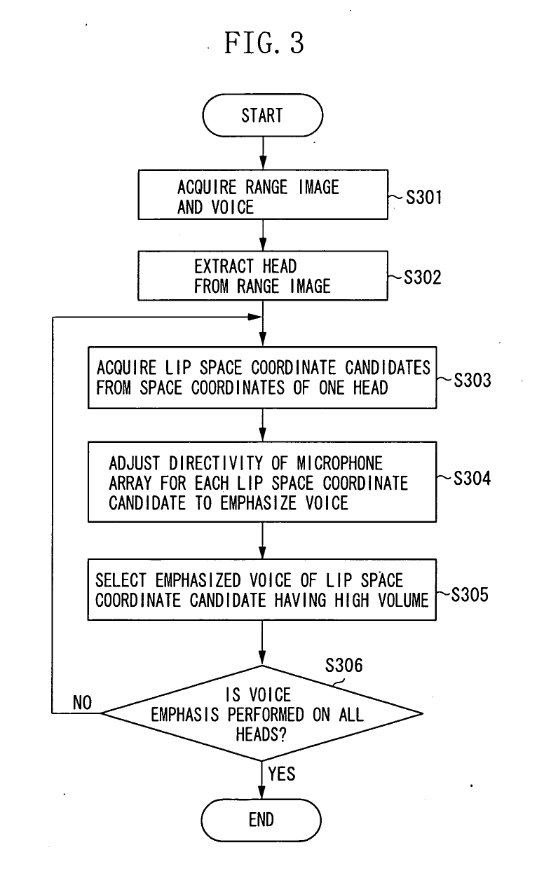

FIG. 3 is a flowchart illustrating a processing flow for emphasizing a voice generated from a sound source of a predetermined coordinates within a three-dimensional area.

First, in step S301, the range image acquisition unit 201 of FIG. 1B acquires a range image. In step S301, the voice acquisition unit 202 of FIG. 1B acquires a plurality of voices recorded via each of the plurality of microphones that form the microphone array 120 of FIG. 1A.

In step S302, the extraction unit 203 of FIG. 1B extracts heads (the tops of the heads) from the range image. The processing in step S302 is described below.

In step S303, the candidate acquisition unit 204 of FIG. 1B acquires a plurality of lip space coordinate candidates from the space coordinates of a target head (the top of the head).

Generally, individual differences of the height from the top of head to lips are relatively small. Accordingly, the height of the lips is determined to be a height from the height of the top of the head to a height (for example, a height separated by 20 cm) separated by a predetermined distance in the normal direction of the reference plane and in the direction the head or the shoulder exists.

On the plane (on the plane parallel to the reference plane) with the height fixed, it is highly possible that the position of the lips exists any one of substantially concentric-circular shaped sections around the periphery of the head (the top of the head) extracted by the extraction unit 203. However, it is difficult to specify the direction of the face by the range image sensor 110 of FIG. 1A or the like that is installed at the upper position, and it is also difficult to specify the position of the lips. Accordingly, one or more lip space coordinate candidates are to be estimated and acquired.

In step S304, the emphasis unit 205 of FIG. 1B adjusts its direction to correspond with each direction of the lip space coordinate candidates using the plurality of voices acquired by the microphone array and emphasizes the voices.

Then, the emphasis unit 205 calculates delay time of the voices arriving at the microphones based on the space coordinates of the microphone array and the direction acquired by one lip space coordinate candidate. The emphasis unit 205 adds the voices by shifting by the delay time and averages the values in order to reduce voices from the other directions and emphasize only the voice of the direction.

The heights of the heads (the tops of the heads) have been known by the range image, and differences in the heights from the tops of the heads to the lips are small as compared to differences between body heights and differences between a standing state and a sitting state of speakers. Accordingly, the voices at the heights around the lips can be adequately emphasized. That is, by the processing in step S304, to one lip space coordinate candidate, one emphasized voice can be acquired.

In step S305, the selection unit 207 of FIG. 1B selects one emphasized voice of a high volume out of the emphasized voices of the individual lip space coordinate candidates generated by the emphasis unit 205. Since the emphasized voices are emphasized in the individual directions of the lip space coordinate candidates, the volumes in the directions other than the directions are reduced. Accordingly, as long as no sound source exists nearby, it is possible to estimate that the direction of the emphasized voice of the high volume is a correct lip space coordinate candidate. Detailed description of the processing for selecting the emphasized voice is described below. Through the above-described processing, one emphasized voice is acquired for one head.

In step S306, the selection unit 207 checks whether the emphasized voices for all the extracted heads are acquired. If the emphasized voices are not acquired for all the extracted heads (NO in step S306), the processing returns to step S303. If the processing is performed to all the heads (YES in step S306), a series of processing ends.

The above-described processing is the processing flow performed by the information processing apparatus according to the present exemplary embodiment.

In step S303, if the space coordinate position of the target head (the top of the head) is at a position 150 cm or more from the floor surface (it is assumed that the height of the ceiling plane is 3 m, and the distance from the ceiling plane is less than 150 cm), the candidate acquisition unit 204 determines a height separated by 20 cm from the top of the head in a predetermined direction to be the height of the lips.

If the space coordinate position of the target head (the top of the head) is at a position less than 150 cm from the floor surface (it is assumed that the height of the ceiling plane is 3 m, and the distance from the ceiling plane is less than 150 cm), the candidate acquisition unit 204 can determine that a height separated by 15 cm from the top of the head in a predetermined direction to be the height of the lips.

As described above, according to the height of the top of the head, by gradually setting the distance from the top of the head to the lips, the height of the lips corresponding to the orientation (for example, a slouching posture) can be estimated. Further, as described above, according to the height of the top of the head, by gradually setting the distance from the top of the head to the lips, in each case where the object is an adult or a child, the height of the lips corresponding to each case can be adequately estimated.

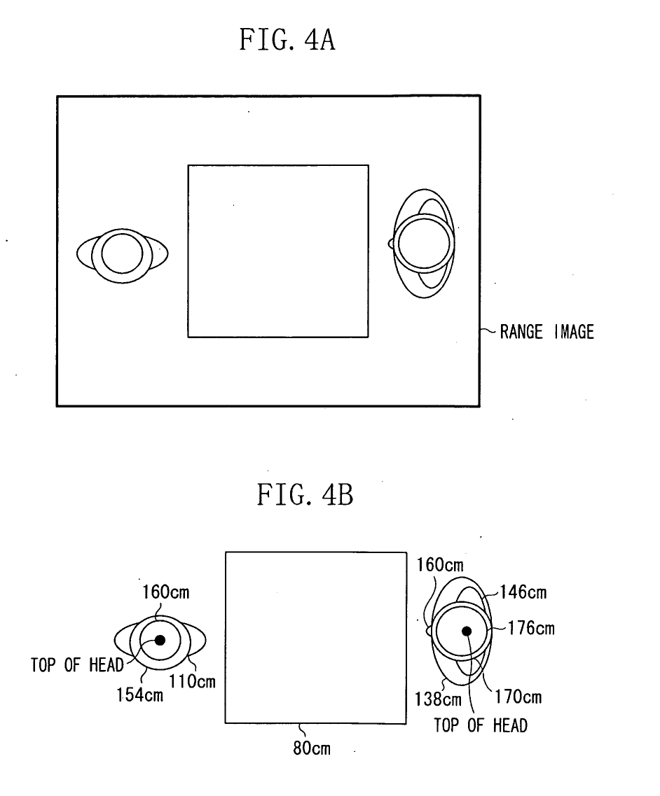

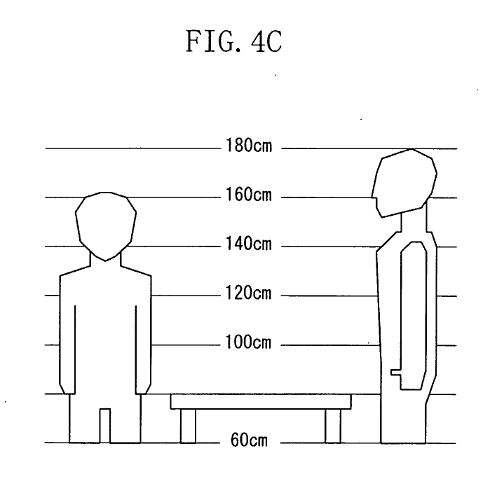

Hereinafter, with reference to FIG. 4, the processing performed in step S302 of FIG. 3 for extracting an area corresponding to the head (the top of the head) of a person from the range image is described.

FIG. 4A schematically illustrates a range image of a case where a three-dimensional space corresponding to at least a part of the conference room illustrated in FIG. 2A is viewed from the ceiling plane in a downward direction (for example, in the vertically downward direction) using contour lines.

FIG. 4B schematically illustrates a state of a case where a three-dimensional space corresponding to at least a part of the conference room illustrated in FIG. 2A is viewed from the ceiling plane in a downward direction (for example, in the vertically downward direction).

FIG. 4C schematically illustrates a state of a case where a three-dimensional space corresponding to at least a part of the conference room illustrated in FIG. 2A is viewed from a side surface (wall surface) in the horizontal direction.

In other words, assuming that the ceiling plane is the reference plane, each pixel (x, y) of the range image illustrated in FIG. 4A forms an image having pixel values based on a distance z from the ceiling plane to the heights illustrated in FIG. 4B. Accordingly, in the range image illustrated in FIG. 4A, an area having features of shapes from the heads to the shoulders described below appears.

For example, assuming that the ceiling plane is the reference plane, the position of the top of the head of the person appears as a point having a minimum distance. Further, the outer circumference of the head appears as an outermost substantially circular-shaped section in substantially concentric-circular shaped sections appeared in the range image. The shoulders of the person appear as a substantially elliptically-shaped section adjacent to the both sides of the outermost substantially circular-shaped section. Accordingly, using a known pattern matching technique, based on the features of the substantially circular-shaped section, the substantially elliptically-shaped section, and the like existing in the range image, and the pixel values of the areas having such features, the extraction unit 203 of FIG. 1B acquires the space coordinate of the head.

The space coordinates can be calculated using the range image itself and imaging parameters such as an installation position of the range image sensor, an installation angle, and an angle of view. In the present exemplary embodiment, the ceiling plane is used as the reference plane, however, other planes can be used as the reference plane. For example, if a horizontal plane of a predetermined height (for example, a height of 170 cm) is to be the reference plane, a position of the top of a head of a person shorter than the predetermined height appears as a point having a minimum distance, and a position of the top of a head of a person taller than the predetermined height appears as a point having a maximum distance. That is, the positions in the three-dimensional area corresponding to the pixels of the extreme values of the distances are to be candidates of positions where the heads of the persons exist.

In order to reduce processing load, without performing the pattern matching or the like, the extraction unit 203 can determine the positions in the three-dimensional area corresponding to the pixels of the extreme values of the distances to be candidates of positions where the heads of the persons exist.

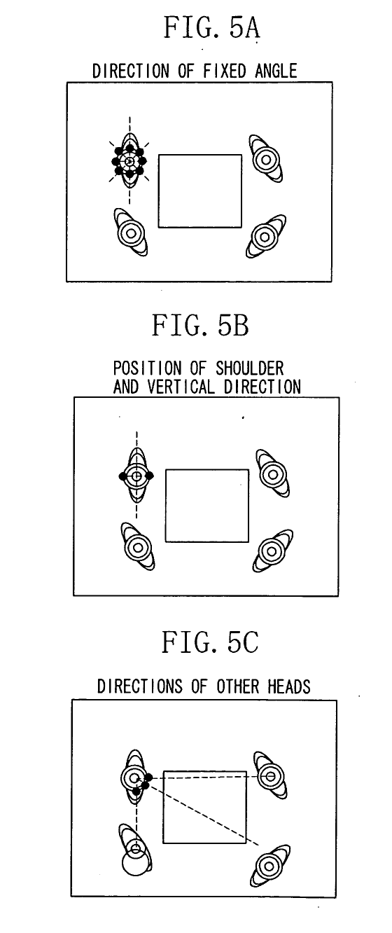

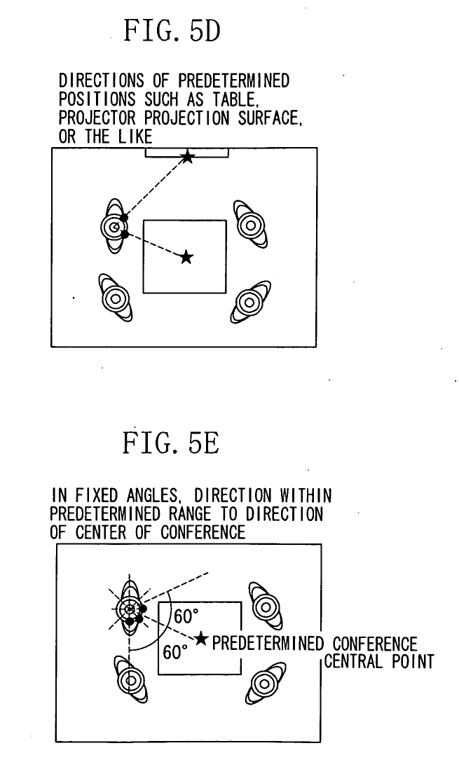

FIGS. 5A to 5E illustrate acquisition state of lip space coordinate candidates from a head in a range image. In FIGS. 5A to 5E, the candidates are acquired by using different methods.

In FIG. 5A, directions (in FIG. 5A, eight directions with 45 degrees to each other) with a fixed angle to each other are to be lip space coordinate candidates. Black circles in FIG. 5A indicate the lip space coordinate candidates. By acquiring a voice emphasized toward a direction of any one of coordinates of the candidates, the voice of the speaker separated from the other voices can be acquired.

In FIG. 5B, positions in directions orthogonal to the direction of the shoulder that comes in contact with the head and in contact with the outer circumference of the head are to be the candidates of the lip space coordinate.

Different from the fixed angle in FIG. 5A, in FIG. 5B, on the assumption that the face direction of the speaker is the same direction as the body direction, the lip space coordinate candidates can be acquired in more detail using the position of the shoulder.

In FIG. 5C, from directions determined from space coordinates of other heads extracted by the extraction unit 203 of FIG. 1B, lip space coordinate candidates are acquired. On the assumption that the speaker faces the direction of other persons, lip space coordinate candidates can be acquired in more detail as compared to the fixed angle in FIG. 5A.

In FIG. 5D, lip space coordinate candidates are acquired from the direction to a predetermined object such as a table, a projector projection surface (wall surface), and the like.

The position of the object that attracts attention of participants such as the table and the projector projection surface (wall surface) is set at the time of installation of the range image sensor 110 of FIG. 1A or by a method at the beginning of the meeting. The position of the table can be set using the range image.

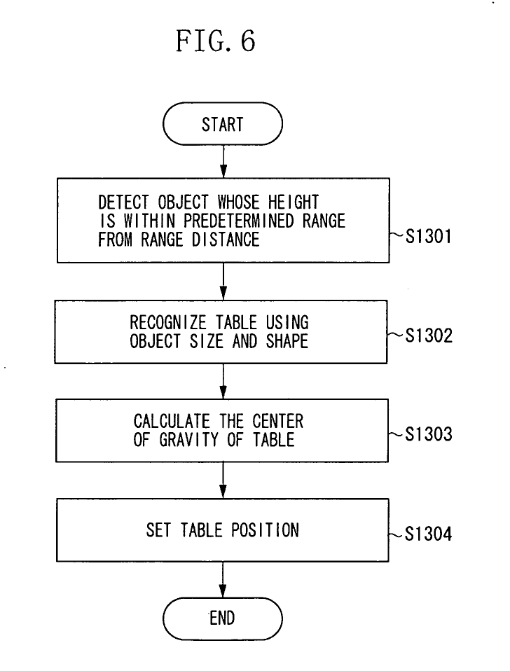

FIG. 6 is a flowchart for setting the table position by recognizing the table from the range image.

First, in step S1301, the calibration unit 211 of FIG. 1B extracts an object whose height is within a predetermined range (for example, from 60 cm to 80 cm) from the range image.

In step S1302, the calibration unit 211 recognizes a table using a size and a shape of the object from the extracted objects. The shape of the table is set to a square, an ellipse, or the like in advance. The calibration unit 211 recognizes only an object that matches with the set size and shape as the table, and extracts the object.

In step S1303, the calibration unit 211 calculates the center of gravity of the recognized table.

In step S1304, the calibration unit 211 sets the center of gravity as the table position. As described above, from the direction calculated from the position of the object set by one of the manual and automatic methods and a head position, the candidate acquisition unit 204 of FIG. 1B acquires lip space coordinate candidates. On the assumption that the speaker faces the direction of the table or the direction of the projector projection plane, the lip space coordinate candidates can be acquired in more detail as compared to the fixed angle in FIG. 5A.

FIG. 5E illustrates a method for determining a direction within a predetermined angular range to the center position of the conference set in advance as candidates.

For example, in FIG. 5E, out of the candidates in the fixed angle in FIG. 5A, candidates included within a range of −60 to +60 degrees to the direction of the center position of the conference are set as the lip space coordinate candidates. The direction of the center position of the conference can be, similar to FIG. 5D, manually set in advance, or automatically set according to the flow in FIG. 6 such that the center of gravity of the table is to be the center position of the conference.

As compared with FIG. 5A, the lip space coordinate candidates can be narrowed using the direction of the center position of the conference. Any of the methods A to E can be employed, or a combination of a plurality of methods can be employed. By combining the methods, using processing performed by the selection unit 207 of FIG. 1B, which is described below, one adequately emphasized voice can be selected from among various lip space coordinate candidates acquired by using various pieces of information.

If there are more candidates, the possibility that an adequate emphasized voice is selected increases. Meanwhile, if there are fewer candidates, a calculation amount such as generation of the emphasized voices can be reduced. Accordingly, according to the environment or the like of installation, a preferable combination can be used.

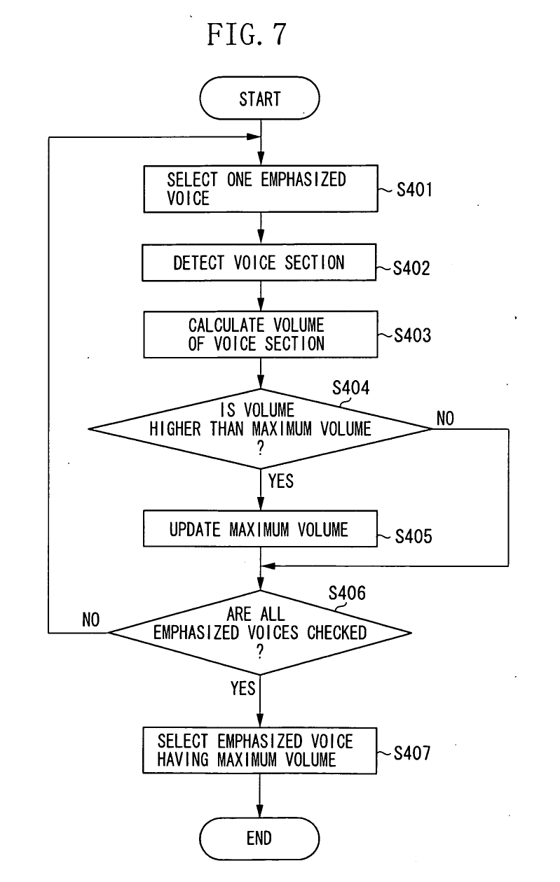

The selection processing of an emphasized voice performed in step S305 of FIG. 3 is described in detail. FIG. 7 is a flowchart illustrating more detailed processing performed in step S305.

In step S401, the selection unit 207 of FIG. 1B selects one emphasized voice corresponding to the lip space coordinate candidate. In step S402, the voice section detection unit 206 of FIG. 1B detects a section of a human voice from the selected voice. The voice section detection can be performed for the emphasized voice or for the voice before the emphasized voice generation acquired by the voice acquisition unit 202 of FIG. 1B. The voice section detection includes already proposed methods using various acoustic features such as volume, a zero-crossing rate, frequency characteristics, or the like, and any detection method can be used.

In step S403, the selection unit 207 calculates a volume of the emphasized voice in the voice section. In step S404, if the volume is higher than the maximum volume (YES in step S404), in step S405, the selection unit 207 updates the maximum volume.

In step S406, the above-described processing is looped and the processing is performed on the emphasized voices corresponding to all the lip space coordinate candidates. In step S407, the selection unit 207 selects an emphasized voice that has a maximum volume in the voice section. In the processing, the voice section detection unit 206 detects the voice section. Accordingly, the selection unit 207 can use the volume of only the voice section and accurately select the emphasized voice that is generated by the speaker. However, the voice section detection unit 206 is not always necessary in the present invention.

The present invention can also be applied to a case where a volume is calculated from the entire emphasized voices and a emphasized voice that has a maximum volume is selected without acquiring the voice section in step S402. Further, in a case where lip space coordinates corresponding to emphasized voices selected in consecutive time largely deviate, an emphasized voice whose volume is higher than a predetermined value (for example, a value whose difference from a maximum value is within a fixed value), and whose change of the lip space coordinates in the consecutive time is small can be selected. Through the processing, the time change of the lip space coordinates can be smoothed.

By the above-described processing, the selection unit 207 selects one emphasized voice from the emphasized voices corresponding to the lip space coordinate candidates.

As described above, by the processing flows illustrated in FIGS. 3 and 7, the lip space coordinates can be accurately acquired using the heads acquired from the range image and the acoustic features of the voices, and the emphasized voices corresponding to the individual persons can be acquired.

Next, processing for performing feedback processing for increasing accuracy of the head extraction using acoustic features of speakers contained in emphasized voices is described.

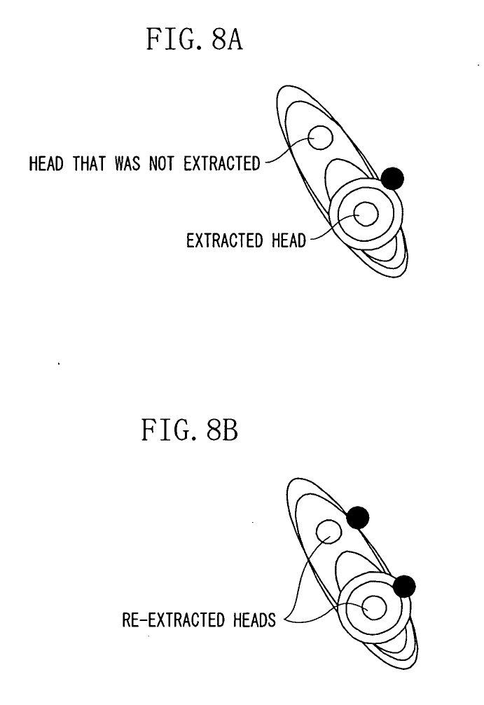

If a plurality of persons stand close to each other, the extraction unit 203 of FIG. 1B may not extract the plurality of heads. FIG. 8A illustrates a case where the extraction unit 203 can extract only one head from two persons standing close to each other. Using the extracted head, only one emphasized voice and a lip space coordinates (black circle in the drawing) corresponding to the emphasized voice are determined.

However, actually, there are two persons. Accordingly, it is preferable to extract the individual heads, estimate the lip space coordinates, emphasize the voices, and associate other emphasized voices with the individual heads.

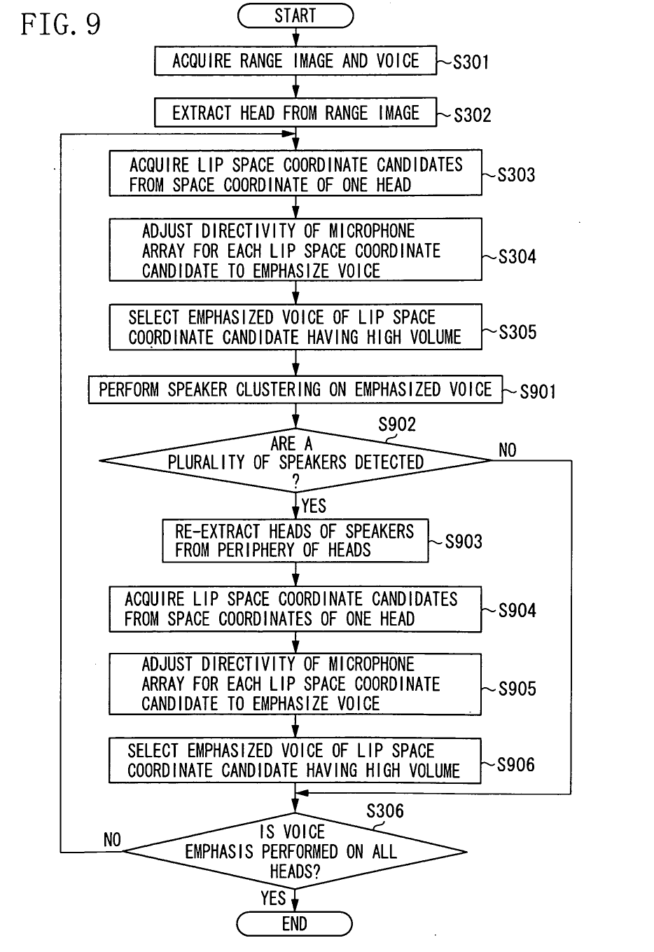

In such a case, according to the number of speakers included in the emphasized voices, the number of the speakers is specified, and the result can be fed back to the head extraction. FIG. 9 is a flowchart illustrating the processing.

In FIG. 9, the processing in steps S301 to S305 correspond to the processing for selecting the emphasized voice in FIG. 3. Accordingly, the same reference numerals are applied, and their descriptions are omitted.

In step S901, the clustering unit 208 of FIG. 1B performs clustering processing on the emphasized voice selected by the selection unit 207 of FIG. 1B, and acquires the number of the speakers included in the emphasized voice.

There are the following methods for the speaker clustering. Speech feature parameters such as a spectrum, a mel-frequency cepstrum coefficient (MFCC) or the like are calculated from a voice for each frame and the values are averaged each predetermined time. Then, clustering processing is performed on the values using a vector quantization method or the like. By the processing, the number of speakers is estimated.

In step S902, if the number of the speakers is one (NO in step S902), the emphasized voice to the head is directly fixed, and the processing proceeds to step S306. If the number of the speakers is more than one (YES in step S902), the processing proceeds to step S903.

In step S903, the re-extraction unit 209 of FIG. 1B estimates heads corresponding to the number of the speakers form the periphery of the heads in the range image and re-extracts the heads. If the persons stand close to each other, in some cases, especially the heights largely differ with each other (for example, one person is sitting and the other one is standing), the heads may not be correctly detected.

FIG. 8A illustrates a case where the extraction unit 203 can extract only one head from two persons standing closely. Using the extracted head, only one emphasized voice and a lip space coordinates (black circle in the drawing) corresponding to the emphasized voice are determined. Then, the clustering unit 208 performs speaker clustering processing on the determined emphasized voice, and the number of the speakers is acquired. For example, if the number of the speakers is two, in step S903, the re-extraction unit 209 searches the current periphery of the head for heads corresponding to the number of the speakers.

The extraction unit 203 of FIG. 1B extracts the heads based on the range image shapes of the heads and shoulders. On the other hand, the re-extraction unit 209 determines and extracts the heads corresponding to the number of the speakers by using a method of lowering a threshold of the matching or simply using a local maximum value of the heights.

FIG. 8B illustrates two heads re-extracted by the re-extraction unit 209 of FIG. 1B according to the number of the speakers. The processing in steps S904 to S906 is performed on each of the re-extracted heads.

In steps S904 to S906, the same processing as in steps S303 to S305 is performed on each of the re-extracted heads. For the individual re-extracted heads, lip space coordinate candidates are acquired, emphasized voices are generated, and an emphasized voice is selected using volumes.

In step S306, similar to FIG. 3, whether the emphasized voices are acquired for all the re-extracted heads, is checked. The two black circles in FIG. 8B are lip space coordinates determined to the individual heads. With respect to the individual heads, emphasized voices whose directivities are adjusted toward the coordinates respectively are associated.

By the above-described processing, the heads are re-extracted using the number of the speakers acquired from the emphasized voices, and the emphasized voices corresponding to the individual re-extracted heads are acquired. Accordingly, even if the heads are closely positioned to each other, the voices corresponding to each speaker can be accurately acquired. In the processing flow in FIG. 9, in the functional configuration in FIG. 1B, the clustering unit 208 and the re-extraction unit 209 are requisite. On the other hand, in the processing flow in FIG. 3, in the functional configuration in FIG. 2, such functions are not always requisite.

In the present invention, further, in extracting a plurality of heads and emphasizing voices of the individual heads, using an emphasized voice acquired from other heads, voices arriving from lip space coordinates of the other heads can be reduced.

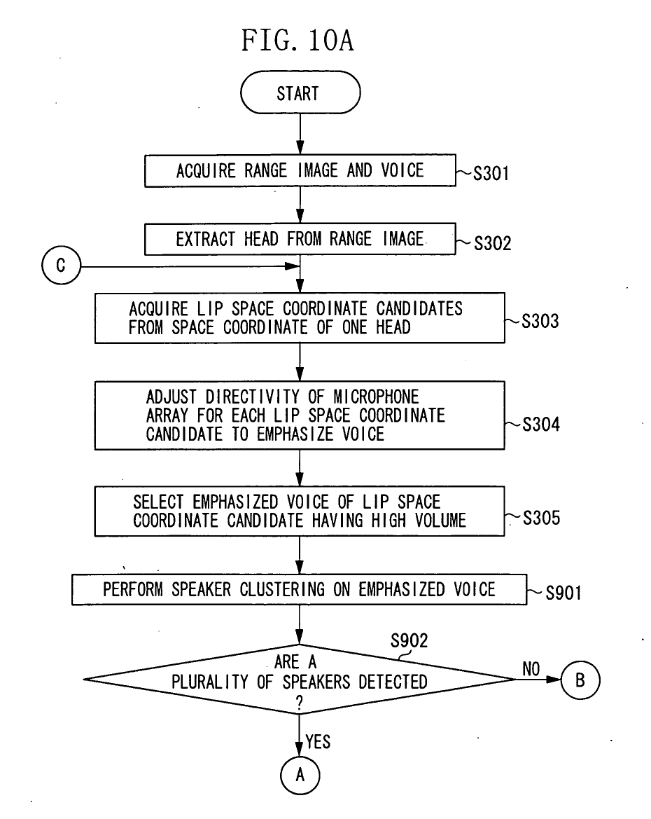

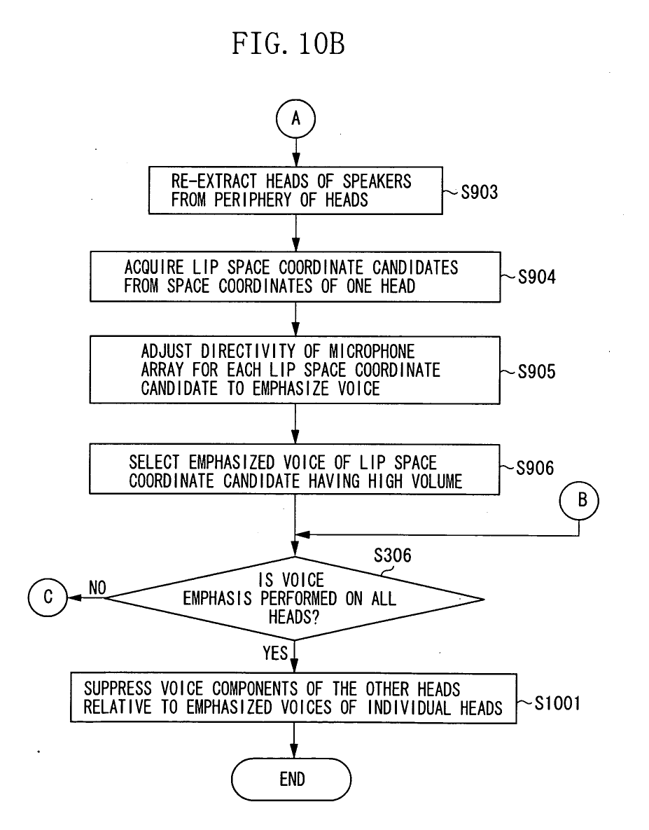

Through the processing, for example, if a person is in silence but another person is speaking, the voice of another person that cannot be removed by the voice emphasis in step S304 can be removed. FIGS. 10A and 10B are flowcharts illustrating the processing, and the flowcharts of FIGS. 10A and 10B may operate in conjunction, for example. In FIGS. 10A and 10B, steps S301 to S306, and steps S901 to S906 are similar to those in FIGS. 3 and 9. Accordingly, the same reference numerals are applied, and their descriptions are omitted.

In step S306, if the emphasized voices are selected to all of the heads, in step S1001, the suppression unit 210 of FIG. 1B suppresses (restricts) voice components of the other heads to the emphasized voices of the individual heads. In a suppression (restriction) method, for example, the emphasized voices of the other heads are subtracted from the emphasized voices. If it is assumed that the spectrum of the emphasized voice of a head is S, and a spectrum of the emphasized voices of the other heads is N(i), the voice components of the other heads can be suppressed (restricted) by the following expression:

S−Σ{a(i)×N(i)}.

In the expression, i is an index of the other heads. The expression a(i) is a predetermined coefficient. The coefficient can be fixed or changed, for example, depending on the distance of the heads.

In step S1001, the suppression (restriction) processing can be performed not by using the suppression unit 210, but by using the emphasized voices of the other heads when the emphasis unit 205 of FIG. 1B performs the voice emphasis processing in step S304. In step S304, the lip space coordinates and the emphasized voices of the individual heads are not determined.

Accordingly, the voice components to be suppressed (restricted) are suppressed (restricted) by determining a rough sound source position using the space coordinates of the heads or the lip space coordinates calculated at the previous time, emphasizing the voice in the direction, generating voices of the other heads, and subtracting the voices from the sound sources of the heads other than the target head from the emphasized voices.

In another method of suppressing (restricting) voices of the other heads, the emphasized voices are correlated with each other. If the correlation is strong, it is determined that the voice of another head is contained, and then, the emphasized voice of a lower volume is set to be silent.

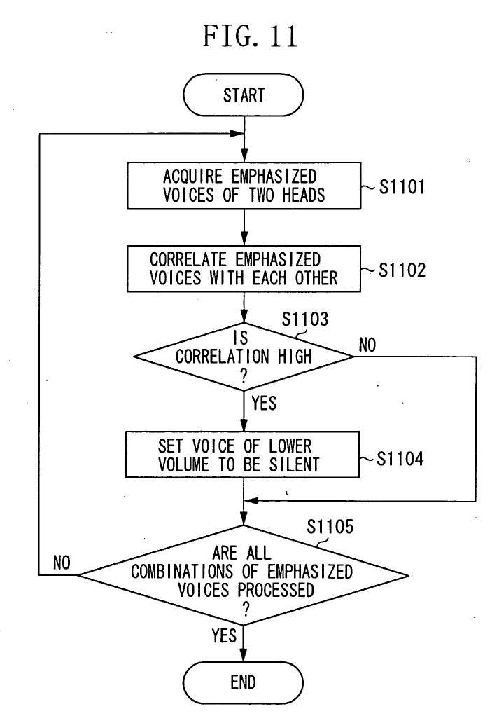

FIG. 11 is a flowchart illustrating the above processing. In step S1101, emphasized voices of two heads are acquired. In step S1102, the two emphasized voices are correlated with each other.

In step S1103, if the correlation is low (NO in step S1103), the processing proceeds to step S1105, and the suppression (restriction) is not performed. If the correlation is high (YES in step S1103), the processing proceeds to step S1104. In step S1104, the volumes of the two emphasized voices are compared. Then, it is determined that the emphasized voice having the lower volume contains the emphasized voice of the higher volume, and the emphasized voice having the lower volume is set to be silent.

In step S1105, the above-described processing is looped and the processing is performed to all combinations of the heads. Through the above processing, the voice containing the voice of another person can be removed. By adding one of the above-described two suppression (restriction) methods, for example, if a person is in silent but another person is speaking, the voice of another person that cannot be removed by the voice emphasis in step S304 of FIG. 10A can be removed.

In the flow illustrated in FIG. 10, in the functional configuration in FIG. 1B, the suppression unit 210 that performs the processing in step S1001 is necessary. However, in the processing flows in FIGS. 3 and 9, in the functional configuration in FIG. 1B, the suppression unit 210 is not always necessary.

According to a second exemplary embodiment of the present invention, if participants of a conference move during the conference, by performing the processing in FIGS. 3 and 7 at each predetermined time interval, adequate emphasized voices of lip space coordinates can be acquired for individual heads (participants) at each predetermined time interval. By tracking the heads extracted by the extraction unit 203 of FIG. 1B continuously, the acquired voices acquired at a certain time interval can be connected, and the voices can be associated with the participants.

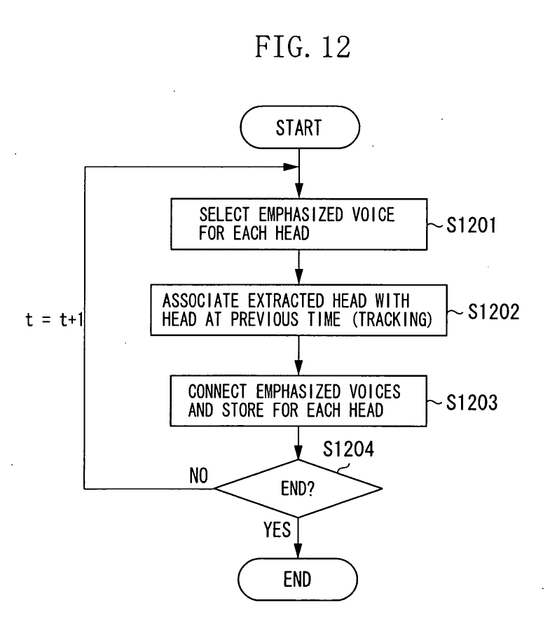

FIG. 12 is a flowchart illustrating the processing of tracking the heads at each predetermined time interval and connecting and recording the emphasized voices.

In FIG. 12, first, in step S1201, emphasized voices are selected for the individual heads according to the processing of the flowchart in FIG. 3. In step S1202, the heads extracted by the extraction unit 203 of FIG. 1B at current time and the heads extracted at previous time are associated with each other based on the closeness in the space coordinates, and the heads are tracked continuously.

In step S1203, based on the associated heads, the emphasized voices are connected with each other, and stored for each head.

It is assumed that a lip space coordinates at time t of a head h is x(h, t) and an emphasized voice signal during a predetermined time interval at time t is S(x(h, t)). Then, a voice Sacc (h, t) stored for each head being tracked is a voice acquired by connecting S(x(h, 1)), S(x(h, 2)) . . . , S(x(h, t)). The voice is looped while the voices are recorded in step S1204.

Through the above-described processing, if the participants of the conference move during the conference, the adequate emphasized voices of the lip space coordinates can be acquired at each predetermined time interval, and the voices tracked and emphasized for the individual heads (participants) can be acquired.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a transitory or a non-transitory recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-148205 filed Jun. 29, 2010, which is hereby incorporated by reference herein in its entirety.

What is claimed is:

1. An information processing apparatus comprising:
an acquisition unit configured to acquire a range image indicating a distance between an object and a reference position positioned within a three-dimensional area;
a first specification unit configured to specify a first position corresponding to a convex portion of the object within the area based on the range image;
a second specification unit configured to specify a second position located in an inward direction of the object relative to the first position; and
a determination unit configured to determine a position of a sound source based on the second position.

2. The information processing apparatus according to claim 1, wherein the second specification unit determines a distance between the first position and the second position based on the first position, and specifies a position separated from the first position in the inward direction of the object by the determined distance as the second position.

3. The information processing apparatus according to claim 1, wherein the reference position is a plane,
the second specification unit specifies the second position that is located in a normal direction of the plane, and in the inward direction of the object based on the first position, and
the determination unit determines that a plane containing the second position, and parallel to the plane is a plane on which the position of the sound source exists.

4. The information processing apparatus according to claim 3, further comprising:
a setting unit configured to set positions of a plurality of points that exist on the plane containing the second position and parallel to the plane, and separated from the second position by a predetermined distance as candidates of the position where the sound source exists; and
wherein the determination unit determines one of the candidates of the position where the sound source exists to be the position of the sound source.

5. A method of operation for an information processing apparatus, the method comprising:
acquiring a range image indicating a distance between an object and a reference position within a three-dimensional area;
specifying a first position corresponding to a convex portion of the object within the area based on the range image;
specifying a second position located in an inward direction of the object relative to the first position; and
determining a position of a sound source based on the second position.

6. A storage medium storing a program for causing a computer to execute the method described in claim 5.
